(19) United States
(12) Patent Application Publication
(10) Pub. No.: US 2008/0304402 A1
(43) Pub. Date: Dec. 11, 2008

(54) Optical Disc Providing a Visual Indication of Its State of Degradation

(75) Inventors: Donato Pasquariello, Eindhoven (NL); Antonius Emilius Theodorus Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,463

(22) PCT Filed: Nov. 22, 2006
(86) PCT No.: PCT/IB2006/054385

§ 371 Date: May 21, 2008

(30) Foreign Application Priority Data
Nov. 28, 2005 (EP) 05111380.1

(51) Int. Cl. G11B 3/70

(52) U.S. Cl. 369/288

(57) ABSTRACT

An optical disc comprises indicator means for indicating to a user the state of degradation of the optical disc. For example, the indicator means can be an indicator layer that is configured to change colour when incorporated into an optical disc, thereby providing an indication that the disc is degrading or ageing, and that it is advisable to transfer the data to another storage medium. According to one embodiment, an optical disc 1, for example a DVD, comprises: a label layer 3; a polycarbonate layer 5; an aluminium/silver layer 7; a dye and data layer 9; an adhesive layer 11; and a second polycarbonate layer 13. In addition, the optical disc 1 comprises indicator means in the form of an indicator layer 15. The indicator layer 15 provides an indication to a user about the state of degradation of the optical disc. The indicator layer 15 is arranged such that at least a portion of the indicator layer 15 coincides with the area in which the data layer 9 is located, and configured such that the indicator layer 15 does not interfere with the normal reading and/or writing of data to the data layer 9.

The invention relates to optical discs, and in particular to an optical disc and a method for providing a visual indication of the state of degradation of an optical disc.

Optical disc technology is extensively used nowadays as a data storage medium. One major disadvantage of using an optical disc as a data storage medium is the uncertainty over the lifetime of an optical disc.

There are three basic types of optical disc, these being CD, DVD and BD (Blu-Ray) discs, each type further having ROM, R, and RW formats. Each of these disc types uses a different data layer material (for example, moulded aluminium, silver mirror, organic dye, or phase-changing film, respectively). Assuming a disc is physically handled properly during use, it is the deterioration of these materials that is the primary cause for disc degradation and, ultimately, “end-of-life” for the disc.

With CDs and DVDs, the user does not notice early degradation because the error detection and correction capability that is built into the system corrects a certain number of errors. The user notices a problem only when the error correction coding is unable to fully correct the errors.

One method for determining the end-of-life for a disc is based on the number of errors on a disc before the error correction occurs. The chance of disc failure increases with the number of errors, but it is impossible to define the number of errors in a disc that will absolutely cause a performance problem (minor or catastrophic) because it depends on the number of errors that remain after error correction, and their distribution within the data. When the number of errors (before error correction) on a disc increases to a certain level, the chance of disc failure, even if small, can be deemed unacceptable and thus signal the end-of-life of the disc.

The longevity of a ROM disc is determined by the extent to which the aluminium layer of the disc is exposed to oxygen. Oxygen, including pollutants, can migrate through the polycarbonate layer or the hard lacquer layer (CD label side and edge), carried in by moisture. Oxygen or moisture can penetrate more easily through scratches, cracks, or delaminated areas in the label. Oxygen can also be trapped inside the disc during manufacturing.

If a disc is left in a very humid environment, moisture and oxygen will eventually reach the aluminium, causing it to lose its reflectivity. This is because the normally shiny aluminium, which resembles silver, becomes oxide-dull and much less reflective. The combination of high humidity and increased temperatures will accelerate the oxidation rate.

The life expectancy of a ROM disc therefore depends on the environmental conditions to which it is exposed over time. Generally, it is best to keep ROM discs in a dry, cool environment.

For “write once” discs (R-discs) that cannot be erased by CD or DVD drives, the mirror normally consists of silver. Silver is susceptible to corrosion if exposed to sulphur dioxide, which is an air pollutant that can penetrate the disc in the same way oxygen can with moisture. Similarly, silver also corrodes when exposed oxygen or moisture.

R-discs use a dye-based layer (organic dye) for recording data. The organic dye used in the data layer of R-discs degrades naturally, but slowly over time. High temperatures and humidity will accelerate the process. Prolonged exposure to UV light can degrade the dye properties and eventually make the data unreadable. Heat build up within the disc, caused by sunlight or close proximity to heated light sources, will also accelerate dye degradation.

Manufacturers claim that CD-R and DVD-R discs have a shelf life of 5 to 10 years before recording, but no expiration dates are indicated on CD-R, DVD-R, or DVD+R packaging, nor are there published reports of tests to verify these claims.

With regard to rewriteable discs such as RW and RAM discs, these are generally not considered for long-term or archival use, and life expectancy tests are seldom performed for this type of medium. Rewritable discs use a phase-changing metal alloy film for recording data, and aluminium or silver for the reflective layer. The alloy film is not as stable as the dye used in R-discs because the material normally degrades at a faster rate. In RW discs one naturally also finds degradation of the reflecting silver or aluminium layers.

The phase-changing film is affected primarily by heat, but also by ultraviolet (UV) light in the aging process. The combination of high temperature and UV light may further accelerate the aging process.

The data on the phase-changing metal alloy film layer can be erased and rewritten a limited number of times (about 1,000 times for RW discs and about 100,000 times for RAM discs). This rewriting does, however, affect disc life expectancy. In other words, RW or RAM discs archived after the first recording should have a longer life expectancy than those that have undergone several erase-recording cycles. Given the normal degradation rate alone, the life expectancy for RW and RAM discs will be less than that of R-discs. Add to that multiple rewrites, and the life expectancy can be even less.

Disc manufacturers sometimes specify the expected lifetime of an optical disc. However, the problem is that the lifetime of a disc is very difficult to predict and depends on many external factors such as the handling of the disc, and environmental conditions. Also, at present there is no standardised way of predicting the lifetime of a disc.

Manufacturers test a disc by using accelerated aging methodologies with controlled extreme temperature and humidity influences over a relatively short period of time. In the same way, optical discs are tested against UV light exposure. However, it is not always clear how a manufacturer interprets its measurements for determining the end-of-life of a disc. Few, if any, life expectancy reports for these discs have been published by independent laboratories. Expectations vary from 5 to 100 years for optical discs. This unknown lifetime reduces user confidence in the use of optical discs as a storage medium.

JP 60-239927 discloses a known system that determines the degradation of a disc during playback by monitoring the signal level of reflected light, thus enabling a warning to be provided to a user that the data should be transferred to a new disc. However, such a system suffers from the disadvantage that the warning system relies on the apparatus actually reading data from the disc, which can lead to a loss of data if the disc suddenly stops working.

JP 03-119533 discloses another known system in which an indicator is placed around the periphery of a disc, and in which a dye fades with respect to time. However, such a system suffers from the disadvantage of not being able to provide an indication about the state of degradation of a particular area on a disc.

The aim of the present invention is to provide an optical disc and a method for providing an indication to a user of the state of degradation of an optical disc, without having the disadvantages mentioned above.

According to a first aspect of the invention there is provided an optical disc comprising a data layer for storing data. The optical disc also comprises indicator means configured to change visual appearance in relation to the state of degradation of the optical disc. The indicator means is arranged to at least partially cover the data layer, and configured such that it does not interfere with the normal operation of the optical disc.

According to another aspect of the present invention, there is provided an optical disc for storing data. The optical disc comprises indicator means configured to change visual appearance in relation to the state of degradation of the optical disc. The indicator means comprises a compound that reacts to the same environmental parameters that are identified as causing degradation of the optical disc.

The invention has the advantage of providing a visual indication about the state of degradation of the disc, based on the actual exposure of the disc to environmental parameters. The arrangement of the indicator means also enables the state of degradation of a particular area of an optical disc to be determined, in addition to the more general state of the disc.

According to another aspect of the invention, there is provided a method of indicating the state of degradation of an optical disc comprising a data layer for storing data. The method comprises the step of providing indicator means that is configured to change visual appearance in relation to the state of degradation of the optical disc. The method also comprises the step of arranging the indicator means such that it at least partially covers the data layer. The indicator means is also configured such that it does not interfere with the normal operation of the optical disc.

For a better understanding of the present invention, and to show more clearly how it may be carried into effect, reference will now be made, by way of example only, to the following drawings in which:

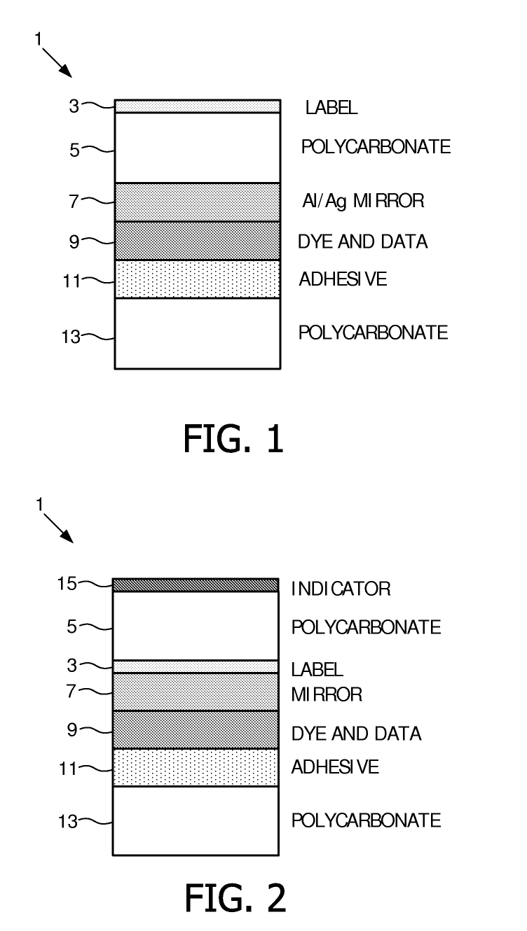

FIG. 1 shows a conventional optical disc;

FIG. 2 shows an optical disc according to a first embodiment of the present invention;

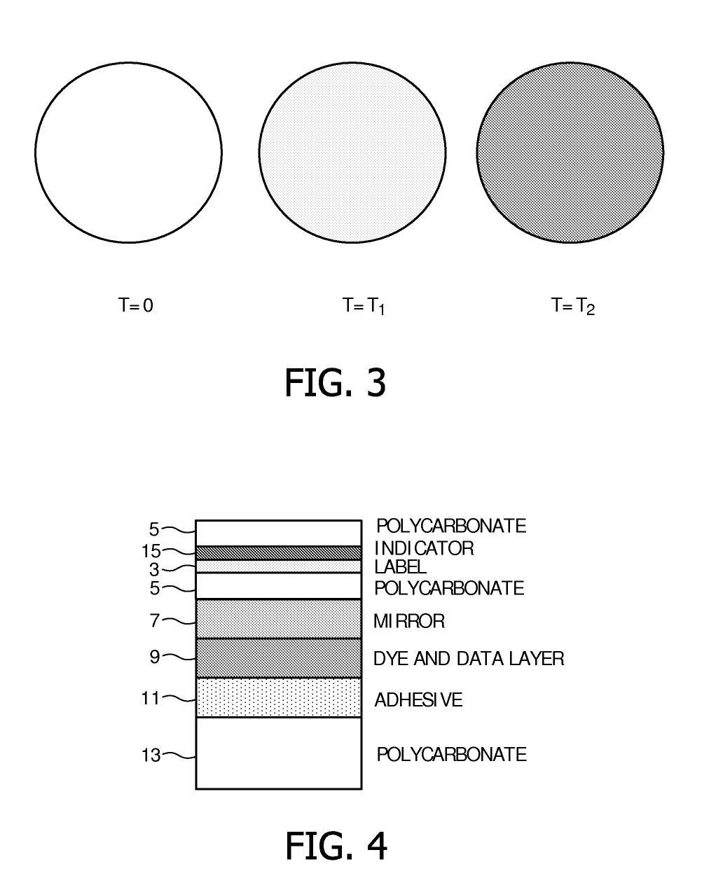

FIG. 3 shows how an optical disc changes visual appearance according to the present invention;

FIG. 4 shows a second embodiment of an optical disc according to the present invention;

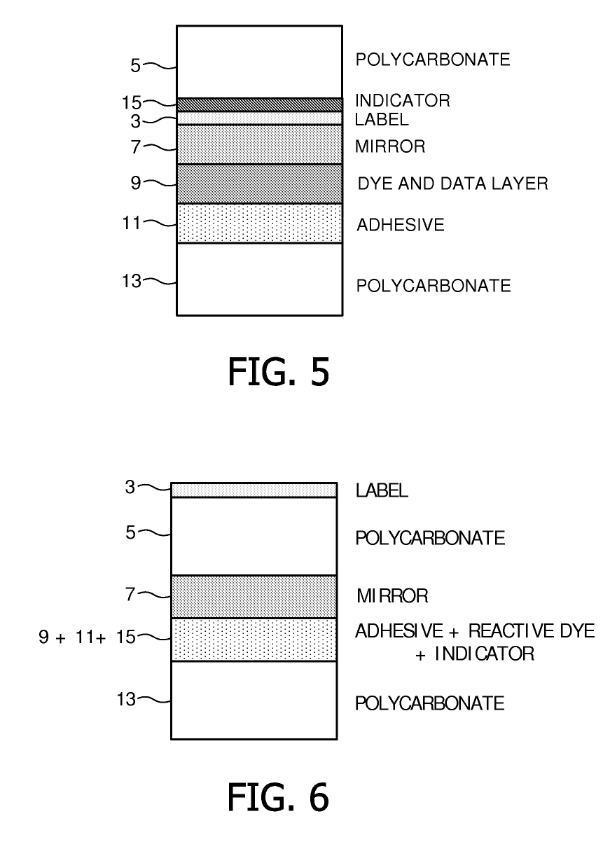

FIG. 5 shows a third embodiment of an optical disc according to the present invention;

FIG. 6 shows a fourth embodiment of an optical disc according to the present invention;

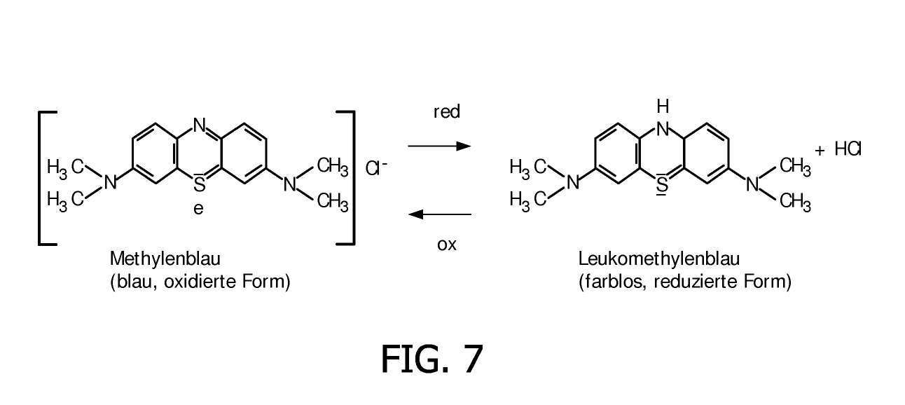

FIG. 7 shows an example of an indicator for use in the present invention;

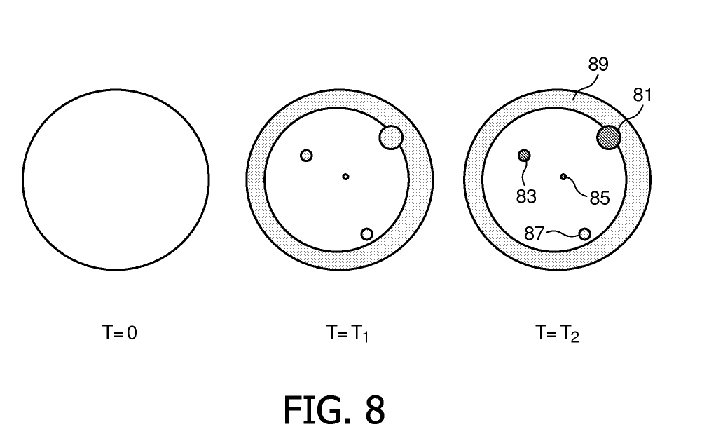

FIG. 8 shows how flaws in an optical disc can be determined using the invention.

FIG. 1 shows a cross section of the layers in a conventional optical disc 1, for example a DVD. The optical disc comprises: a label layer 3; a polycarbonate layer 5; an aluminium/silver layer 7; a dye and data layer 9; an adhesive layer 11; and a second polycarbonate layer 13. The functioning and purpose of each of these layers will be clearly evident to a person skilled in the art, and will therefore not be described in further detail in this application.

According to the invention, the optical disc is provided with indicator means for indicating to a user the state of degradation of the optical disc.

For example, the indicator means can be an indicator layer that is configured to change colour when incorporated into an optical disc, thereby providing an indication that the disc is degrading or ageing, and that it is advisable to transfer the data to another storage medium.

FIG. 2 shows an optical disc according to one embodiment of the present invention. As with FIG. 1, the optical disc 1, for example a DVD, comprises: a label layer 3; a polycarbonate layer 5; an aluminium/silver layer 7; a dye and data layer 9; an adhesive layer 11; and a second polycarbonate layer 13. However, in accordance with the invention, the optical disc 1 also comprises indicator means in the form of an indicator layer 15. The indicator layer 15 provides an indication to a user about the state of degradation of the optical disc.

The indicator layer 15 is arranged such that at least a portion of the indicator layer 15 coincides with the area in which the data layer 9 is located. In other words, the indicator layer 15 is arranged to be in the same area, or overlapping with the data layer 9. Preferably the indicator layer 15 coincides with the entire area in which the data layer 9 is located. It will be appreciated that the indicator layer 15 is configured such that the colouring of the indicator layer 15 does not interfere with the normal reading and/or writing of data to the data layer 9.

This has the advantage that the visual appearance of the indicator layer 15 provides an accurate indication of the state of degradation of the disc in that particular area of the disc, in addition to providing a general indication about the overall state of the disc in more general terms.

The indicator layer 15 is configured such that it turns colour after an incubation time that depends on one of a number of environment parameters such as oxygen diffusion, humidity or temperature, or any combination thereof. Since disc degradation is also heavily dependent on oxygen diffusion, humidity and temperature, the invention makes it possible to relate the colouring of the disc to the degradation of the disc.

In other words the indicator means provided in the optical disc has a property that changes physical appearance in response to the same factors which cause the degradation of the optical disc.

Although the invention described in FIG. 2 (and the remaining Figures) is described in relation to the colour of the indicator means 15 changing in response to environmental conditions, it will be appreciated that some other form of visual characteristic could also be made to change. For example, the indicator means 15 could be configured to provide another visual effect, such as a “blistering look” or a “cracked look” as the indicator changes over time, thereby providing an indication to a user that the data should be transferred to a new disc.

Also, it is noted that the term “changing colour” includes amongst other things the changing from a “clear” state into a particular colour, changing from one colour into another colour, or changing from a shade of one colour into another shade of the same colour.

FIG. 3 shows how the colour of the disc changes over time, thereby providing an indication of the state of degradation of the optical disc. At time T=₀ the indicator layer 15 is clear, thereby indicating that the disc is in an excellent state. At time T=T₁ the colour has changed slightly, thereby indicating that the disc is becoming slightly degraded. At time T=T₂ the colour has changed significantly, thereby indicating that the data should be transferred as soon as possible to a new disc. In this way, the indicator layer 15 is configured such that it provides an indication of the extent to which the optical disc is degrading with respect to its expected end-of-life.

The indicator layer can also be “tuned” to be sensitive to UV light, which is another well-known source for disc degradation. For example, the incubation time of the indicator layer 15 can be tuned by increasing or reducing the colouring agent in the indicator layer. Once the disc turns blue, for example, the user knows that it is time to back-up the data on the disc. The data on the disc is still accessible even if the disc changes colour. The advantage of indicator layers is that the user knows exactly when the disc is degrading, as compared to an indication from the manufacturer, which does not include for example regional differences in humidity and temperature, or the amount of exposure to UV light.

It will be appreciated that the indicator layer 15 can be placed in any position within the stack of layers in an optical disc. For example, FIG. 4 shows the polycarbonate layer 5 sandwiching the indicator layer 15 and the label layer 3. FIG. 5 shows the polycarbonate layer 5 followed by the indicator layer 15, followed by the label layer 3.

FIG. 6 shows a DVD-ROM in which the indicator layer 15 is provided as a reactive dye that is mixed into the adhesive 11, which makes the process very simple. For BD this may also be possible but the optical requirements are more stringent. Naturally, the reactive dye is transparent before the incubation time. The reactive dye can also be mixed into the polycarbonate substrate (for DVD) 5, 13, or inside the polycarbonate substrate or inside the cover sheet (for BD).

The concept of having an indicator layer 15 can be applied to all optical disc formats, including but not limited to CD, DVD, HDDVD, and BD (-ROM, -R and -RW). As seen from the above, there are numerous options regarding where to place the indicator layer in the stack. However, these options can be separated into two main categories: 1) placing the indicator behind the reflective mirror and 2) placing the indicator in-front of the reflective mirror. When placing the indicator layer in-front of the reflective mirror the indicator layer can be integrated in the adhesive, which makes the process very cost efficient.

It will be appreciated by a person skilled in the art that various reactive dyes and photo-bleaching agents can be used as the indicator means.

For example, the indicator means in the indicator layer 15 could comprise a dye containing leuco methylene blue, which is a well-known indicator agent in redox-based titrations. The coloring mechanism is then based on the oxidation of leuco methylene blue (transparent) into methylene blue (blue). In other words, using this dye as the indicator layer 15 will result in the reactive dye going from transparent to blue when oxidised.

FIG. 7 shows the reversible reduction-oxidation process of leuco methylene blue (transparent) into methylene blue (blue).

Preferably, the indicator layer 15 can be configured such that it can be tuned. For example, the reactive dye can also contain Sn(II) 2-ethyl hexonoate, which makes it possible to tune the colouring mechism. In this manner, the color transformation can be controlled by another oxidation reaction, relating to the transition of Sn(II) 2-ethyl hexanoate into Sn(IV) 2-ethyl hexanoate. This latter conversion is not an equlibrium reaction, as opposed to the methylene blue redox couple. The oxidation potential of Sn(II) 2-ethyl hexanoate is much lower than that of leuco methylene blue. Consequently, in the presence of an oxidant (oxygen from the ambient, H₂O, etc.) all the Sn(II) salt will first oxidized and form Sn(IV).

When all Sn(II) is consumed, the oxidation and coloration of leuco methylene blue will start. The concentration of Sn(II) 2-ethyl hexanoate in the dye layer will determine the incubation time before the disc starts to turn blue. The time can be controlled by the amount of Sn(II) 2-ethyl hexanoate in the reactive dye. Hence, adding or substrating the Sn(II) 2-ethyl hexanoate content in the dye layer will increase or reduce, respectively, the incubation time before the disc starts to turns blue.

Another way of controlling the incubation time before the disc starts to turn blue is to cover the dye with oxygen diffusion barriers such as silicon nitride (Si₃N₄) or polymers, for example. There are a number of possible materials that can be used as diffusion barriers. The diffusion of oxygen through the diffusion barrier is governed by the equation:

$$C ( x , t ) = {C}_{s} erfc ( \frac{x}{\sqrt{2 Dt}} ) \qquad ( 1 )$$

Therefore, the addition of a oxygen diffusion barrier increases the incubation time for colouring of the disc. As can be seen from equation (1), the incubation time can be extended considerably in this way.

Another way of controlling the incubation before the disc starts to turn blue is to tune the oxygen permeability of the polycarbonate substrate or the cover-sheet in an optical disc. The oxygen permeability of the polycarbonate substrate determines the oxygen diffusion through it.

The incubation time before the colouring of the disc commences is related to the oxidation of leuco methylene blue (transparent) into methylene blue (blue). Therefore, the invention has the advantage of enabling scratches of the polycarbonate substrate to be detected by the colouring mechasim. This is because oxygen and moisture can penetrate more easily through scratches, cracks and deliminated areas resulting in disc failure. Scratches, cracks and delamination result in a faster selective colouring of the disc.

Referring to FIG. 8, at time T=T₀ when the disc is new, the disc is perfectly clear because it has not aged or degraded, and there are no scratches. However, at time T=T₁, it can be seen that certain parts of the disc have begun to degrade, and some parts more than others due to scratches or cracks. At time T=T₂, it can be seen how the disc is degrading in general terms, but also how certain portions, for example 81, 83, 85, have degraded more than other portions (such as portion 89) because of damage to the disc. It can also be seen that the scratch 81 is older than the scratch 87.

From the above it will be appreciated that the invention provides a convenient way of providing an indication to a user about the state of degradation of the disc, including any damage that has been experienced by certain parts of the disc.

The proposed indicator means identified above, leuco methylene blue, is a useful candidate as it traces oxidation by oxygen or water. Oxidation is a serious risk for the disc performance, as it will deteriorate the mirror layer, which has been found to be one of the main lifetime problems in climate tests. This is not the only cause for degradation, however. The indicator should also be able to monitor temperature and UV-exposure induced reduction of disc performance. UV-sensitive organic compounds that change color upon exposure will be known to a person skilled in the art. Temperature indicators are also well-known, but for this application one would prefer a monitor that measures some accumulated value (integration of heat exposure over time). An organic molecule that starts to decompose at, say, 50° C. into colored fragments may be used for this purpose.

In the embodiments described above, it is noted that the “state of degradation of the disc” is intended to convey the state of degradation of the disc with respect to its expected end-of-life. In other words the indicator means provided in the optical disc has a property that changes physical appearance in response to the same factors that cause the degradation of the optical disc, and at the same rate as the expected lifetime of the optical disc.

It will be appreciated that the indicating means or layer can be placed in numerous other configurations within the optical disc, whilst still being encompassed by the scope of the appended claims.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim.

1. An optical disc for storing data, the optical disc comprising:
a data layer for storing data;
indicator means configured to change visual appearance in relation to the state of degradation of the optical disc;
wherein the indicator means is arranged to at least partially cover the data layer, and configured such that it does not interfere with the normal operation of the optical disc.

2. An optical disc as claimed in claim 1, wherein the indicator means comprises a compound that reacts to the same environmental parameters that cause degradation of the optical disc.

3. An optical disc as claimed in claim 1, wherein the indicator means is configured to change colour according to the degradation of the optical disc.

4. An optical disc as claimed in claim 1, wherein the indicator means comprises a dye containing leuco methylene blue.

5. An optical disc as claimed in claim 1, further comprising means for delaying the time before the indicator means starts to change visual appearance.

6. An optical disc as claimed in claim 5, wherein the means for delaying the time before the indicator means starts to change visual appearance comprises an incubator agent.

7. An optical disc as claimed in claim 6, wherein the incubator agent comprises Sn(II) 2-ethyl hexonoate.

8. An optical disc as claimed in claim 5, wherein the means for delaying the time before the indicator means starts to change visual appearance comprises a diffusion barrier, for delaying the environmental parameters from reaching the indicator means.

9. An optical disc as claimed in claim 8, wherein the diffusion barrier comprises a silicon nitride (Si₃N₄) or polymer barrier.

10. An optical disc as claimed in claim 5, wherein the means for delaying the time before the indicator means starts to change visual appearance comprises means for adjusting the oxygen permeability of a polycarbonate substrate or a cover sheet of the optical disc, for delaying the environmental parameters from reaching the indicator means.

11. An optical disc as claimed in claim 1, wherein the indicator means is provided as an indicator layer in the optical disc.

12. An optical disc as claimed in claim 10, wherein the indicator layer is located to a reflective side of the data layer.

13. An optical disc as claimed in claim 10, wherein the indicator layer is located to a non-reflective side of the data layer.

14. An optical disc as claimed in claim 1, wherein the indicator means is provided in a polycarbonate substrate layer, in an adhesive layer or in a cover sheet of the optical disc.

15. An optical disc claimed in claim 1, wherein the indicator means is configured to change visual appearance according to its exposure to any one of the environmental parameters including oxygen diffusion, humidity, temperature and UV light, or any combination thereof.

16. An optical disc for storing data, the optical disc comprising;
indicator means configured to change visual appearance in relation to the state of degradation of the optical disc;
wherein the indicator means comprises a compound that reacts to the same environmental parameters that cause degradation of the optical disc.

17. A method of indicating the state of degradation of an optical disc comprising a data layer for storing data, the method comprising the steps of:
providing indicator means that is configured to change visual appearance in relation to the state of degradation of the optical disc; and
arranging the indicator means such that it at least partially covers the data layer, and configuring the indicator means such that it does not interfere with the normal operation of the optical disc.
